(19) United States
(12) Patent Application Publication
(10) Pub. No.: US 2009/0066749 A1
(43) Pub. Date: Mar. 12, 2009

(54) Collecting waste ink in a printer system

(76) Inventors: Paul D. Young, San Diego, CA (US); Xiangdong Zhao, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/899,514

(22) Filed: Sep. 6, 2007

(51) Int. Cl. B41J 2/165

(52) U.S. Cl. 347/36

(57) ABSTRACT

A method and system of dynamically collecting waste ink in a printing system is disclosed. The method includes providing a collection reservoir for the waste ink wherein the waste ink has a conductance, positioning at least two electrodes in the collection reservoir and sensing the conductance of the waste ink so as to determine when the collection reservoir needs to be serviced.

### BACKGROUND

In commercial, industrial, and retail based printing system, there can be a sizable amount of waste ink. This may come from two sources: overspray due to inaccuracies and tolerances of producing a full (or partial) bleed print, and aerosol from the ink deposition process itself. In smaller printing systems, this waste ink can be managed with a disposable absorber, commonly called a diaper. In larger or higher volume printing systems, the ink flux is much greater and an ink gathering system must be employed. One such system uses a bottle or other container as a collection reservoir to accumulate and store the waste ink.

A problem exists however in determining when the waste reservoir is full and needs replacing and/or cleaning. If servicing is deferred too long, the reservoir can overflow and cause damage to the printing system, ruin the customer prints, stain the store or site where the system is installed and even generate environmental hazards. Servicing too soon costs extra time and money, wastes resources and causes additional down time for the printer thereby reducing overall productivity.

### BRIEF DESCRIPTION OF THE DRAWINGS

FIG. 1 is a high-level flowchart of a method in accordance with an embodiment.

FIG. 2 illustrates a system in accordance with an embodiment.

FIG. 3 illustrates a waste ink collection unit in accordance with an embodiment.

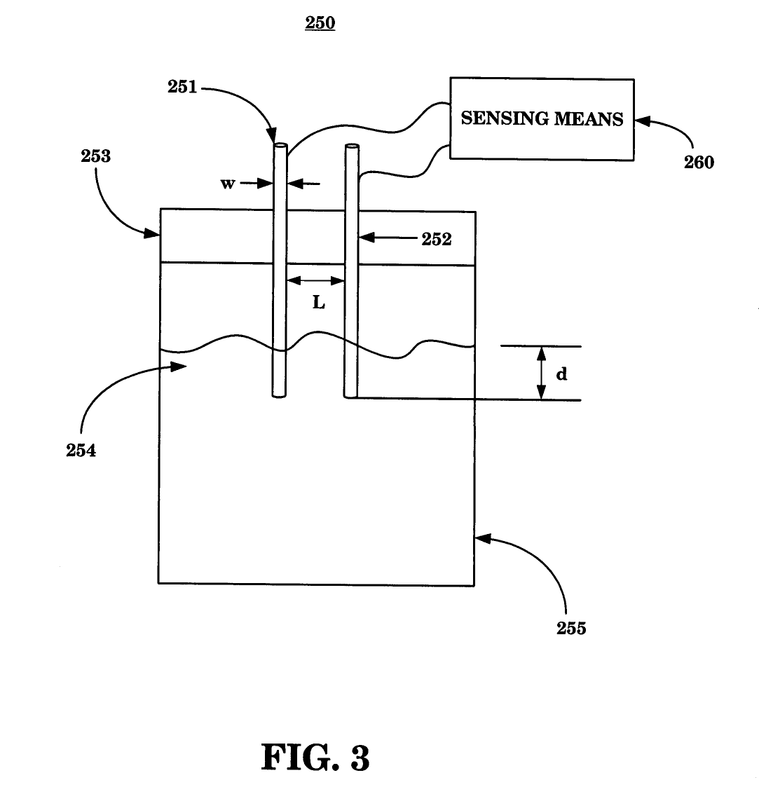

FIG. 4 illustrates an analog sensing means for sensing a conductance in the waste ink in accordance with an embodiment.

FIG. 5 illustrates a digital sensing means for sensing a conductance in the waste ink in accordance with an embodiment.

### DETAILED DESCRIPTION

A method and system for collecting waste ink in a printer is disclosed. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

In varying embodiments, the method and system utilizes the conductivity of the ink itself in order to determine whether the waste ink has reached a predetermined threshold amount thereby indicating that the waste ink reservoir needs to be serviced (emptied, changed, etc.). As a result, an accurate and inexpensive means for sensing the waste ink level in a waste ink reservoir is created thereby enabling the timely disposal or servicing thereof.

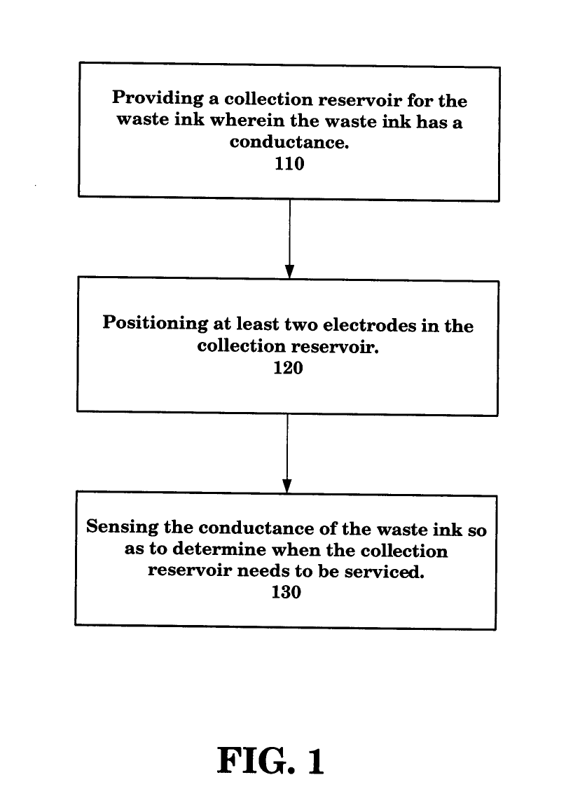

FIG. 1 is a flowchart of a method in accordance with an embodiment. A first step 110 involves providing a collection reservoir for the waste ink wherein the waste ink has a conductance. A next step 120 includes positioning at least two electrodes in the collection reservoir. A final step 130 involves sensing the conductance of the waste ink so as to determine when the collection reservoir needs to be serviced. Again, by utilizing the conductivity of the waste ink itself to determine whether the waste ink has reached a predetermined threshold level in the collection reservoir, an accurate and inexpensive means for sensing the waste ink level is created.

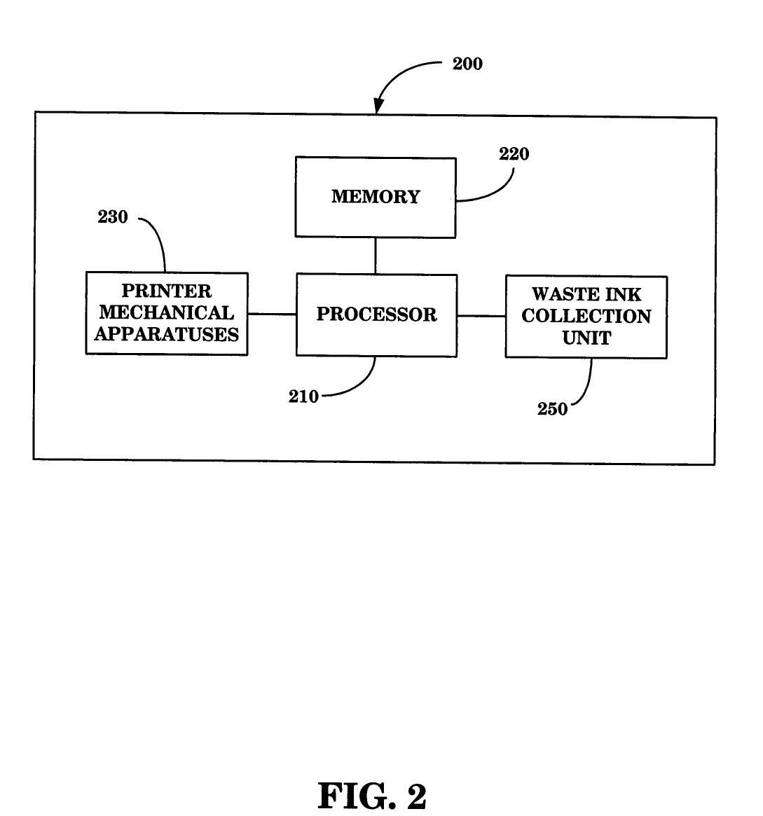

FIG. 2 high-level illustration of a printing system 200 in accordance with an embodiment. The system includes a processor 210 coupled to a memory 220, printer mechanical apparatuses 230 and a waste ink collection unit 250. The processor 210 controls the functions of the printing system 200 wherein the functions performed by the printer are stored in the printer memory 220. The memory 220 incorporated in the printer may be ROM, PROM, flash memory, NVRAM, or any combination of these. For example, the printer's core functions for movement of the printer's mechanical apparatuses 230 could be stored in ROM while the color tables and dithering algorithms are stored in the programmable memory.

Although the above-delineated embodiment is described in the context of implementing the disclosed printer elements, one of ordinary skill in the art will readily recognize that these printer elements are mere examples. A variety of additional elements could be employed while remaining within the spirit and scope of the present inventive concepts.

The system 200 further includes a waste ink collection unit 250. Waste ink that accumulates as a result of overspray due to inaccuracies and tolerances of producing a full (or partial) bleed print, and aerosol from the ink deposition process itself is collected in the waste ink collection unit 250. In an embodiment, the waste ink collection unit 250 a collection reservoir 255 with a removable cap 253. The unit 250 further includes at least two electrodes 251, 252 coupled to a sensing means 260 for sensing a conductance of the collected waste ink 254. In an embodiment, the collection reservoir 255 is a molded bottle wherein the electrodes 251, 252 are simple wire electrodes that can be molded into the reservoir 255 or the removable cap 253.

As the waste ink 254 level rises, the ink 254 will eventually contact the electrodes 251, 252. This creates a conductance path between the electrodes 251, 252 that can be sensed by the sensing means 260 in order to determine the level of the ink 254 itself. The longer the electrodes 251, 252, the greater the range of levels that can be measured in an analog fashion. Alternatively, the electrodes 251, 252 can be relatively short, and positioned near the top of the reservoir to sense the ink level in a digital (on/off) fashion.

Ink conductivity depends on the ink type, formulation, carrier solvent, and other factors. For pigment based inks, waste ink volume resistivities are approximately 3000 ohm-meters (Ω·m). This value is relatively constant and does not change appreciably over time. Accordingly, the formula for determining resistance between the electrodes is:

R=p×L÷(w×d)

where p is the volume resistivity, L is the interelectrode spacing, w is the electrode width and d is the immersion depth.

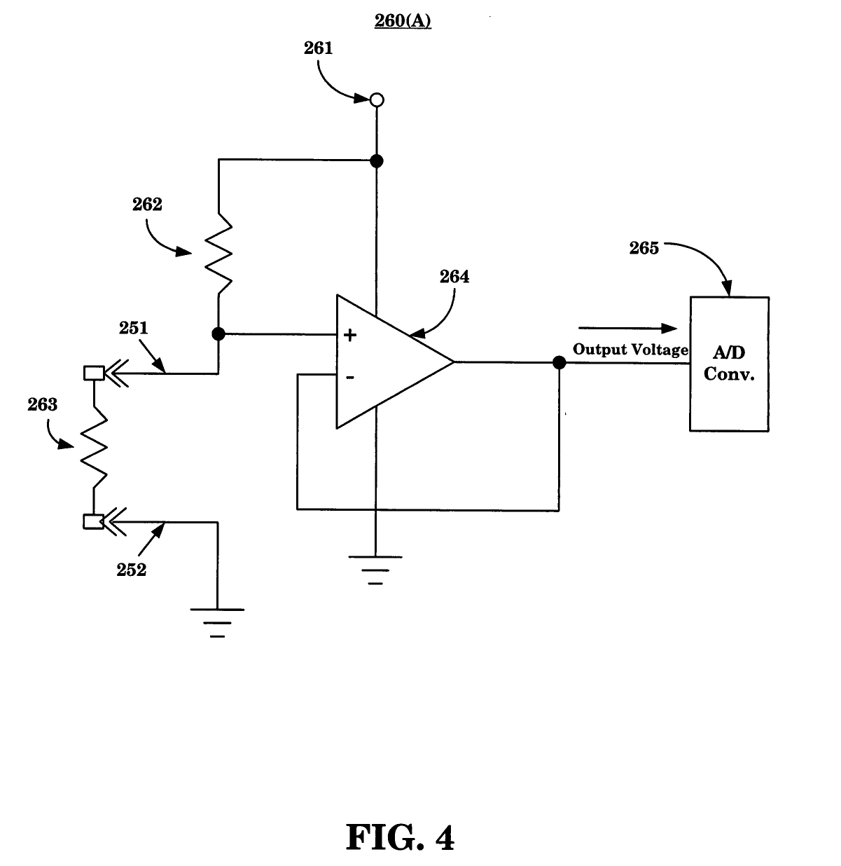

For analog measurement, FIG. 4 shows a configuration 260(A) in accordance with an embodiment. FIG. 4 shows electrode 251 coupled to an operational amplifier 264 wherein the operational amplifier 264 is coupled to an analog-to-digital converter 265. A source resistor 262 is shown whereas ink resistance 263 is the resistance between the electrodes 251, 252 due to the ink.

In an embodiment, the operational amplifier 264 is used in a non-inverting buffer configuration (i.e., the output of the amplifier is an exact replica of the input). Additionally, the operational amplifier 264 has an extremely high input impedance (typically, greater than 10⁹Ω) so as to not adversely influence the measurement of the ink conductivity. In an embodiment, the operational amplifier 264 produces an output voltage of 5 volts for essentially infinite resistance. This is the case when the waste ink is below the electrodes. The output voltage accordingly becomes correspondingly lower as the ink contacts and progresses up the electrodes 251, 252. The formula for the output voltage is:

Vₒ=Vₛ×Rₓ+(Rₛ+Rₓ)

where Vₛ is the source voltage 261, Rₛ is the source resistor 262 and Rₓ is the ink resistance between the electrodes 251, 252 due to the ink 254. This output voltage is fed into the A/D converter 265 where it can be read by the processor 210 to determine the approximate level of the waste ink 254.

During operation of the analog embodiment, the electrodes 251, 252 are positioned in the collection reservoir 255. When the waste ink 254 contacts the electrodes 251, 252, a conductance path is created between the electrodes 251, 252. Accordingly, the analog sensing means 260(A) measures the approximate level of the waste ink 254. Based on the position of the electrodes, an alarm is triggered by the processor 210 to notify the user that the collection reservoir 255 needs to be serviced. For example, if the electrodes 251 are positioned substantially near the top, the alarm indicates that the collection reservoir 255 should be serviced immediately. If the electrodes 251, 252 are positioned at a lower point in the collection reservoir 255, the alarm could indicate that the collection reservoir 255 should be serviced at a predetermined time interval (a week, a month, etc.).

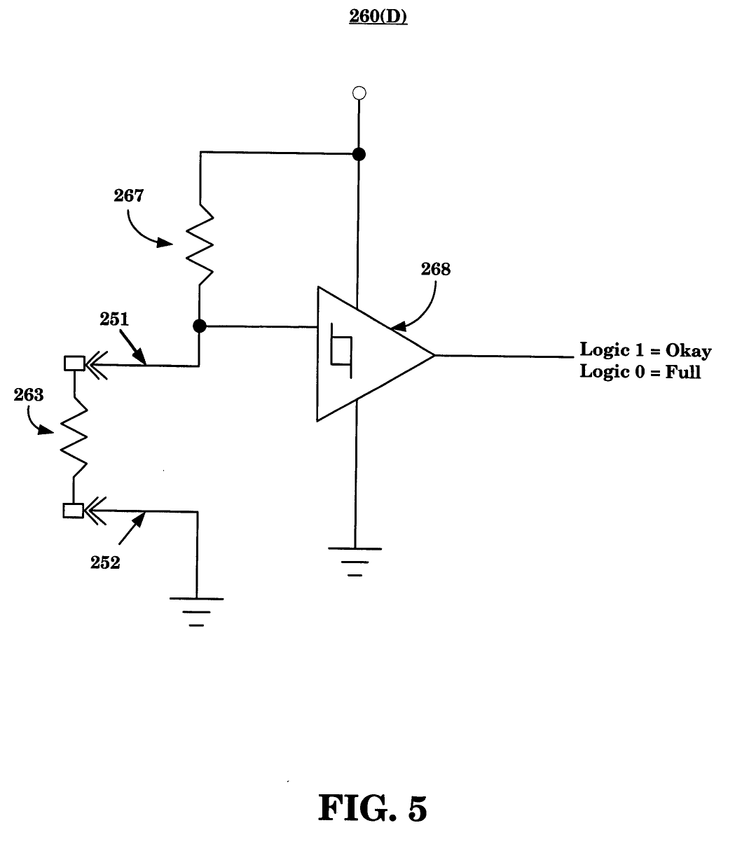

For digital measurement, FIG. 5 shows a configuration 260(D) in accordance with an embodiment. FIG. 5 shows electrode 251 coupled to comparator 268 and a divider resistor 267. In an embodiment, the comparator 268 is a Schmitt Trigger. A Schmitt Trigger is a comparator circuit that incorporates positive feedback. Accordingly, when an input is higher than a certain chosen threshold, the output is high; when the input is below another (lower) chosen threshold, the output low; when the input is between the two, the output retains its value.

The benefit of the Schmitt Trigger over a circuit with only a single input threshold is greater stability (noise immunity). With only one input threshold, a noisy input signal near that threshold could cause the output to switch rapidly back and forth from noise only. Consequently, the use of the Schmitt Trigger ensures that the gate output will have a solid, stable transition and won't oscillate when the waste ink conductivity is near the threshold of the gate.

Referring to FIG. 2, during operation of the digital embodiment, the electrodes 251, 252 are positioned substantially near the top of the collection reservoir 255. Accordingly, when the waste ink 254 reaches a level that contacts the electrodes 251, 252, the digital sensing means 260(D) detects the conductance of the waste ink 254 and a “full” signal is sent to the printer processer 210 whereby an alarm can be activated to alert the system user that the collection reservoir 255 needs to be serviced immediately. Alternatively, if the electrodes 251, 252 are positioned at some predetermined distance below the top of the collection reservoir 255, the alarm could indicate that the collection reservoir 255 should be serviced at a predetermined time interval (a week, a month, etc.).

A method and system of dynamically collecting waste ink in a printing system is disclosed. The method includes providing a collection reservoir for the waste ink wherein the waste ink has a conductance, positioning at least two electrodes in the collection reservoir for sensing the conductance and sensing the conductance of the waste ink so as to determine when the collection reservoir needs to be serviced. In an embodiment, the method and system utilizes the conductivity of the ink itself in order to determine whether the waste ink has reached a predetermined threshold amount thereby indicating that the waste ink reservoir needs to be serviced (emptied, changed, etc.). As a result, an accurate and inexpensive means for sensing the waste ink level in a waste ink reservoir is created thereby enabling the timely disposal thereof.

Without further analysis, the foregoing so fully reveals the gist of the present inventive concepts that others can, by applying current knowledge, readily adapt it for various applications without omitting features that, from the standpoint of prior art, fairly constitute the characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A method of collecting waste ink in a printer system comprising:
providing a collection reservoir for the waste ink wherein the waste ink comprises a conductance;
positioning at least two electrodes in the collection reservoir; and
sensing the conductance of the waste ink so as to determine when the collection reservoir needs to be serviced.

2. The method of claim 1 wherein the collection reservoir further comprises a molded bottle.

3. The method of claim 2 wherein the molded bottle further comprises a removable bottle cap and positioning the at least two electrodes in the collection reservoir further comprises:
molding the at least two electrodes into the removable bottle cap.

4. The method of claim 1 wherein sensing the conductance of the waste ink further comprises:
utilizing an analog circuit to sense a level of waste ink in the collection reservoir.

5. The method of claim 4 wherein the analog circuit further comprises:
a source resistor coupled to at least one of the at least two electrodes;
a single operational amplifier; and
an analog-to-digital converter coupled to the single operational amplifier.

6. The method of claim 1 wherein positioning at least two electrodes in the collection reservoir further comprises positioning the at least two electrodes substantially near a top portion of the collection reservoir and sensing the conductance of the waste ink further comprises:
utilizing an digital circuit to sense the conductance of the waste ink in the collection reservoir.

7. The method of claim 6 wherein the digital circuit further comprises:
a divider resistor coupled to at least one of the at least two electrodes; and
a single comparator coupled to the divider resistor.

8. The method of claim 7 wherein the single comparator further comprises a Schmitt Trigger.

9. A waste ink collection unit comprising:
a collection reservoir for collecting the waste ink wherein the waste ink has a conductance;
at least two electrodes coupled to the collection reservoir; and
sensing means coupled to the collection reservoir and the at least two electrodes for sensing the conductance so as to determine when the collection reservoir needs to be serviced.

10. The waste ink collection unit of claim 9 wherein the collection reservoir further comprises a molded bottle.

11. The waste ink collection unit of claim 10 wherein the molded bottle further comprises a removable bottle cap the at least two electrodes are molded into the removable bottle cap.

12. The waste ink collection unit of claim 9 wherein the sensing means further comprises an analog circuit.

13. The waste ink collection unit of claim 12 wherein the analog circuit further comprises:
a source resistor coupled to at least one of the at least two electrodes;
a single operational amplifier; and
an analog-to-digital converter coupled to the single operational amplifier.

14. The waste ink collection unit of claim 9 wherein the at least two electrodes are positioned substantially near a top of the collection reservoir and the sensing means further comprises a digital circuit.

15. The waste ink collection unit of claim 9 wherein the digital circuit further comprises:
a divider resistor coupled to at least one of the at least two electrodes; and
a single comparator coupled to the divider resistor.

16. The waste ink collection unit of claim 15 wherein the single comparator further comprises a Schmitt Trigger.

17. The waste ink collection unit of claim 9 wherein the at least two electrodes are positioned such that an alarm operatively coupled to the at least two electrodes indicates that the collection reservoir should be serviced at a predetermined time interval.

18. A printing system comprising:
a processor; and
a waste ink collection unit coupled to the processor wherein the waste ink collection unit further comprises a collection reservoir for collecting the waste ink wherein the waste ink has a conductance wherein the collection reservoir further comprises a molded bottle;
at least two electrodes coupled to the molded bottle; and
sensing means coupled to the molded bottle for sensing the conductance so as to determine when the molded bottle needs to be serviced.

19. The system of claim 18 wherein the wherein the sensing means further comprises an analog circuit and the analog circuit comprising a source resistor coupled to at least one of the at least two electrodes, a single operational amplifier and an analog-to-digital converter coupled to the single operational amplifier.

20. The system of claim 18 wherein the at least two electrodes are positioned substantially near a top of the molded bottle and the sensing means further comprises a digital circuit comprising a divider resistor coupled to at least one of the at least two electrodes and a Schmitt Trigger coupled to the divider resistor.
